(19) United States
(12) Patent Application Publication
(10) Pub. No.: US 2014/0156997 A1
(43) Pub. Date: Jun. 5, 2014

(54) SYSTEM AND METHOD FOR AUTHENTICATING AN ENCODED MULTIMEDIA STREAM USING DIGITAL SIGNATURES

(71) Applicant: ITTIAM SYSTEMS (P) LTD., Bangalore (IN)

(72) Inventors: BHAVANI GOPALAKRISHNA RAO, Bangalore (IN); Abhinandan Kedlaya, Bangalore (IN)

(73) Assignee: Ittiam Systems (P) Ltd., Bangalore (IN)

(21) Appl. No.: 13/693,067

(22) Filed: Dec. 4, 2012

(51) Int. Cl. H04L 9/32

(52) U.S. Cl. CPC H04L 9/3247
USPC 713/176

(57) ABSTRACT

A system and method for authenticating an encoded multimedia stream are disclosed. In one embodiment, one or more digital signatures associated with one or more decodable units in the encoded multimedia stream are generated, in real-time. Further, the generated digital signatures are embedded into the encoded multimedia stream.

### TECHNICAL FIELD

Embodiments of the present subject matter generally relate to authenticating an encoded multimedia stream. More particularly, embodiments of the present subject matter relate to authenticating the encoded multimedia stream using digital signatures.

### BACKGROUND

Multimedia stream authentication is a requirement in many media centric applications. Content authentication is used to prove that the content has not been modified once generated from its original source. It is an essential requirement in video security applications where recorded audio-video content can be used for criminal investigations and even offered as evidence in court. Here it is necessary to prove that the audio-video content presented, is authentic and has not been modified or tampered with, once recorded by the security camera or other devices. Authentication may also be required in property rights protection. For example media content from the entertainment industry is required to bear copyright notices and notices to indicate if the content has been modified. Any unauthorized modifications or illegal recordings can be identified if a strong authentication mechanism is built into the content itself.

Authentication of multimedia content can be enabled using digital signatures. The digital signature has to be generated such that it can detect even the minutest form of modification or tampering and conclusively authenticate the streams. Tampering for multimedia content may include modifying images in the video (for example, blurring a portion of an image in a video sequence), silencing audio for durations of time, deleting video for duration of time, modifying audio corresponding to a given video and so on. The signatures thus need to capture the essence of the streams at a given point in time as well as that over duration of time. Existing techniques typically can detect modifications in a given frame of video but would leave any discontinuity of video, such as deletion or insertion of video frames into the original sequence of frames, undetected.

Existing techniques generate signatures in the form of separate certificates that need to be available along with the content for authentication. This inherently introduces a restriction that authentication is not possible, unless the multimedia content and the corresponding certificate are available in their entirety. This implies that authentication in real-time multimedia applications such as video streaming from a media server to a media client is not possible using this method. Real-time authentication requires the signatures to be also transmitted live, along with the content. While carrying it live, there needs to be a provision based on which the signature can be associated with a specific instant or portion of the multimedia stream.

Existing techniques for signature generation are primarily encryption or similar techniques, which are computation intensive and do not always lend themselves to be used in real-time systems. In real-time systems, the signature generation technique needs to be computationally less complex while retaining its effectiveness to detect tampering.

### BRIEF DESCRIPTION OF THE DRAWINGS

Various embodiments are described herein with reference to the drawings, wherein:

FIG. 1 illustrates a flowchart of a method for authenticating an encoded multimedia stream, according to one embodiment;

FIG. 2 illustrates a block diagram including major components of a transmitter, where the transmitter is any system or device that encodes multimedia streams and embeds digital signatures or embeds the digital signatures into pre-encoded multimedia streams for such purposes as recording and streaming, and their interconnectivity, according to one embodiment;

FIG. 3 illustrates another block diagram including major components of the transmitter and their interconnectivity, according to one embodiment;

FIG. 4 illustrates yet another block diagram including major components of the transmitter and their interconnectivity, according to one embodiment;

FIG. 5 illustrates a block diagram including major components of a receiver and their interconnectivity, according to one embodiment; and

FIG. 6 illustrates another block diagram including major components of the receiver and their interconnectivity, according to one embodiment.

The drawings described herein are for illustration purposes only and are not intended to limit the scope of the present disclosure in any way.

### DETAILED DESCRIPTION

A system and method for authenticating an encoded multimedia stream using digital signatures are disclosed. In the following detailed description of the embodiments of the present subject matter, references are made to the accompanying drawings that form a part hereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

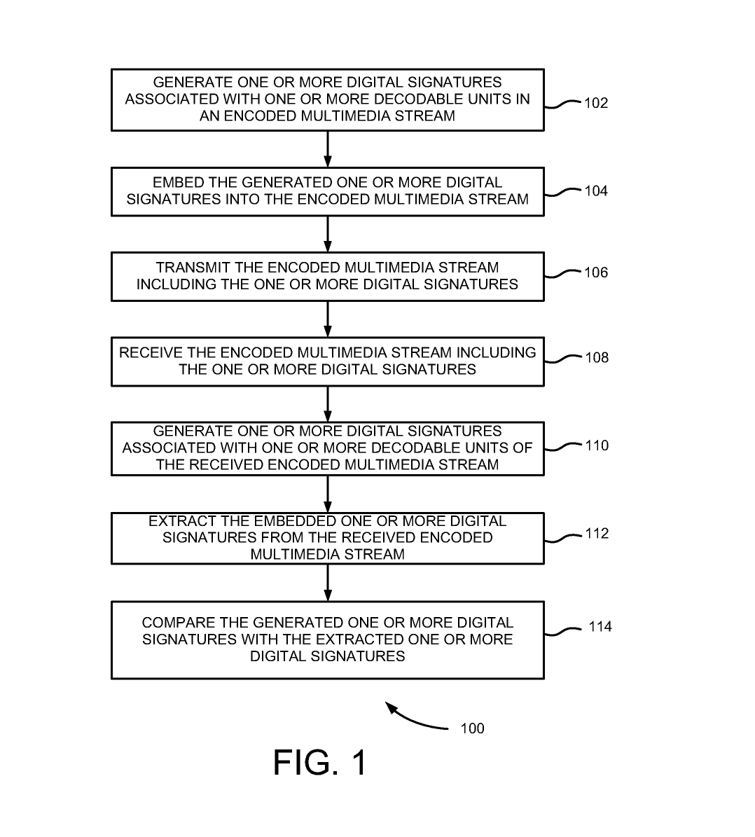

FIG. 1 illustrates a flowchart 100 of a method for authenticating an encoded multimedia stream, according to one embodiment. At block 102, one or more digital signatures associated with one or more decodable units in an encoded multimedia stream are generated, in real-time. Exemplary multimedia stream includes video streams, audio streams, images and associated metadata. For example, the metadata is data associated with the video streams, audio streams or images, such as global positioning system (GPS) co-ordinates of a location and the like. For example, the decodable unit is an independently decodable segment of an audio or video elementary stream such as a slice or a field picture or a frame as defined by the respective compression standards. In one embodiment, the digital signatures are generated, in real-time, using associated multimedia stream properties. For example, multimedia stream properties include statistics or values derived from bit rates, video buffer verifier (VBV) buffer fullness, quantization levels, transform coefficients and so on or a checksum of decodable unit(s) generated by operations, such as cyclic redundancy check (CRC) and the like. In one exemplary embodiment, the multimedia stream properties corresponding to an instant of time or accumulated over duration of time are used for the generation of the digital signatures. For example, the accumulated values are values obtained from a systematic sum or any other set of operations across the multimedia stream properties corresponding to the instant of time.

At block 104, the generated digital signatures are embedded into the encoded multimedia stream. In one embodiment, the digital signatures are embedded, in real-time, into the encoded multimedia stream. In one exemplary embodiment, the generated digital signatures are embedded, in real-time, as part of user specific data in decodable units. User specific data can be carried in fields reserved for the purpose in the syntax specified by most multimedia compression standards, such as those defined by groups such as MPEG (moving pictures expert group) and ITU-T (international telecommunication union). The user specific data can be inserted into fields such as user data in MPEG-2 and MPEG-4 compression standards or can be inserted in supplemental enhancement information (SEI) or video usability information (VUI) messages in a H.264 compression standard. In another exemplary embodiment, the digital signatures are appended at an end of each decodable unit. Appending the digital signatures at the end of each decodable unit enables frequent insertion of the digital signatures without affecting decodability. In another embodiment, the generated digital signatures are embedded into the encoded multimedia stream with a time or byte offset along with information to associate the digital signature with a portion of the encoded multimedia stream. In this embodiment, the digital signatures corresponding to a decodable unit may not be embedded in the same decodable unit itself. It may be embedded into another decodable unit. In one exemplary implementation, the generated digital signatures are encrypted using a private key. Further, the encrypted digital signatures are embedded into the encoded multimedia stream.

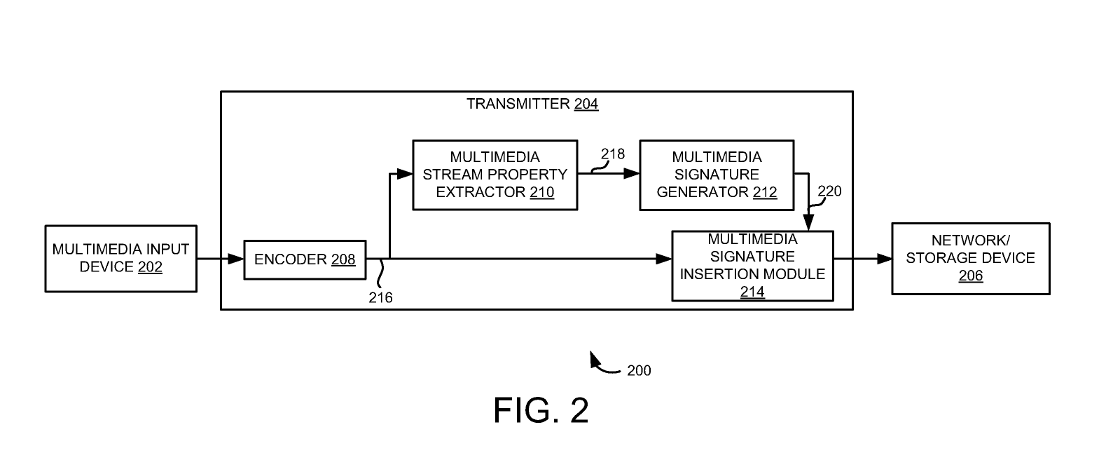

At block 106, the encoded multimedia stream including the digital signatures is transmitted. In one embodiment, the encoded multimedia stream including the encrypted digital signatures is transmitted. At block 108, the encoded multimedia stream including the digital signatures is received. At block 110, one or more digital signatures associated with one or more decodable units in the received encoded multimedia stream are generated. In one embodiment, the digital signatures associated with the decodable units in the received encoded multimedia stream are generated using the associated multimedia stream properties. At block 112, the embedded digital signatures are extracted from the received encoded multimedia stream. For example, the user specific data including the embedded digital signatures is extracted. At block 114, the extracted digital signatures are compared with the generated digital signatures to determine whether the transmitted encoded multimedia stream and the received encoded multimedia stream are identical or not. In one embodiment, the extracted signatures are decrypted using a public key. Further, the decrypted signatures are compared with the generated signatures to determine whether the encoded multimedia stream and the received encoded multimedia stream are identical or not. This is explained in more detail using FIGS. 2-6.

Referring now to FIG. 2, which is a block diagram 200 that illustrates major components of a transmitter 204 and their interconnectivity, according to one embodiment. As shown in FIG. 2, the block diagram 200 includes a multimedia input device 202, the transmitter 204, and a network or storage device 206. Further, the transmitter 204 includes an encoder 208, a multimedia stream property extractor 210, a multimedia signature generator 212 and a multimedia signature insertion module 214. Furthermore, the multimedia input device 202 is coupled to the transmitter 204. Particularly, the multimedia input device 202 is coupled to the encoder 208. In addition, the encoder 208 is coupled to the multimedia stream property extractor 210 and the multimedia signature insertion module 214. Moreover, the multimedia stream property extractor 210 is coupled to the multimedia signature generator 212. Also, the multimedia signature generator 212 is coupled to the multimedia signature insertion module 214. Further, the transmitter 204 is coupled to the network or storage device 206.

In operation, the transmitter 204 receives an input multimedia stream from the multimedia input device 202. Particularly, the encoder 208 receives the input multimedia stream from the multimedia input device 202. Exemplary multimedia stream includes video streams, audio streams, images and associated metadata. Further, the encoder 208 encodes the input multimedia stream and sends the encoded multimedia stream 216 to the multimedia stream property extractor 210 and the multimedia signature insertion module 214. Furthermore, the multimedia stream property extractor 210 extracts multimedia stream properties 218 associated with one or more decodable units in the encoded multimedia stream 216 from the encoded multimedia stream 216. In addition, the multimedia stream property extractor 210 sends the extracted multimedia stream properties 218 to the multimedia signature generator 212. Moreover, the multimedia signature generator 212 generates, in real-time, one or more digital signatures 220 associated with the decodable units using the associated extracted multimedia stream properties 218.

Also, the multimedia signature generator 212 embeds the generated digital signatures 220 into the encoded multimedia stream 216 using the multimedia signature insertion module 214. In one exemplary embodiment, the multimedia signature generator 212 encrypts the generated digital signatures 220. The multimedia signature generator 212 then embeds the encrypted digital signatures into the encoded multimedia stream 216. In one embodiment, the multimedia signature generator 212 embeds, in real-time, the generated digital signatures 220 into the encoded multimedia stream 216. In one exemplary implementation, the multimedia signature generator 212 embeds, in real-time, the generated associated digital signatures as part of user specific data in each decodable unit in the encoded multimedia stream 216. In another exemplary implementation, the multimedia signature generator 212 appends the generated associated digital signatures at the end of each decodable unit in the encoded multimedia stream 216. In another embodiment, the multimedia signature generator 212 embeds the generated digital signatures 220 into the encoded multimedia stream 216 with a time or byte offset along with information to associate the digital signature with a portion of the encoded multimedia stream.

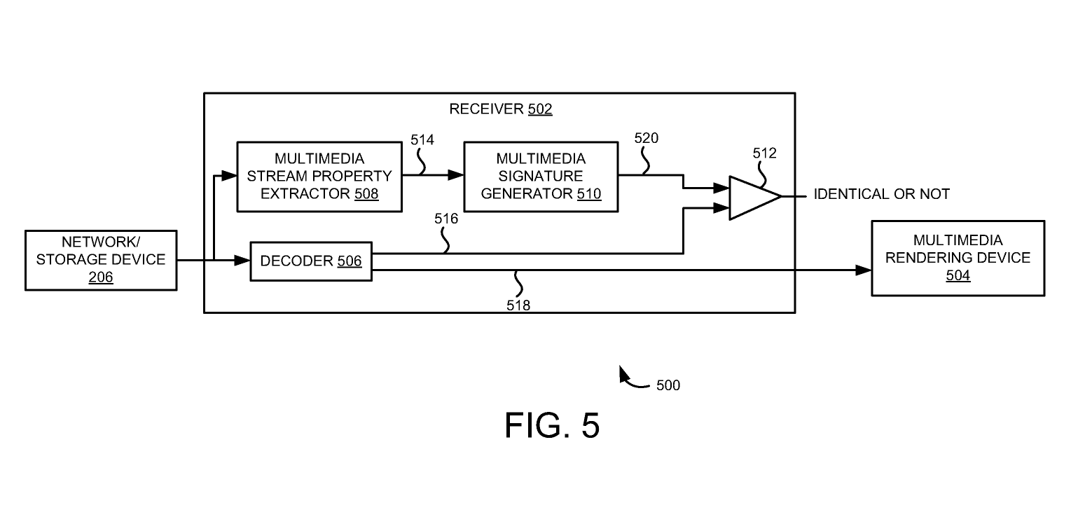

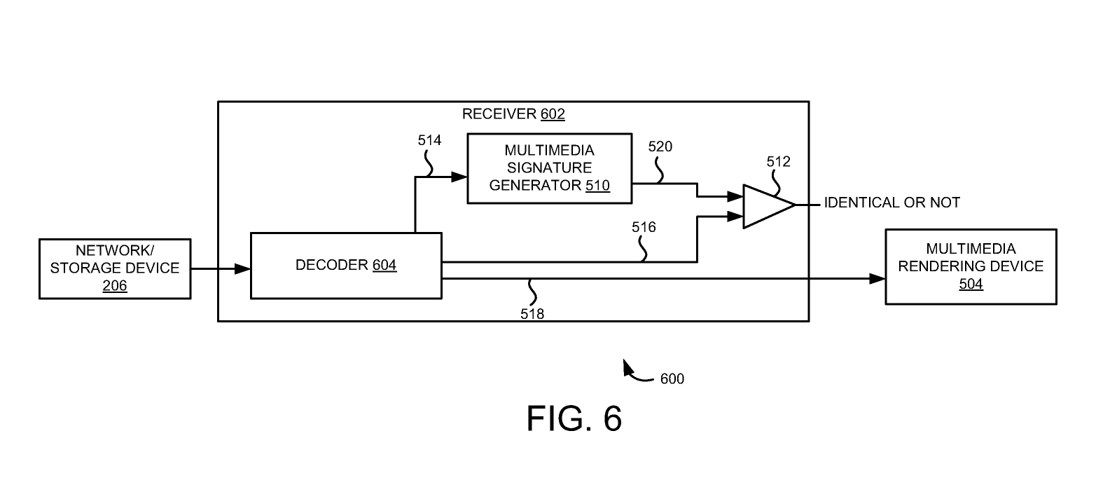

Further, the transmitter 204 transmits the encoded multimedia stream including the digital signatures to the network or storage device 206. In one embodiment, a receiver (e.g., a receiver 502 of FIG. 5 or a receiver 602 of FIG. 6) receives the encoded multimedia stream including the digital signatures from the network or storage device 206 and authenticates the received encoded multimedia stream using the digital signatures. This is explained in more detail using FIGS. 5 and 6.

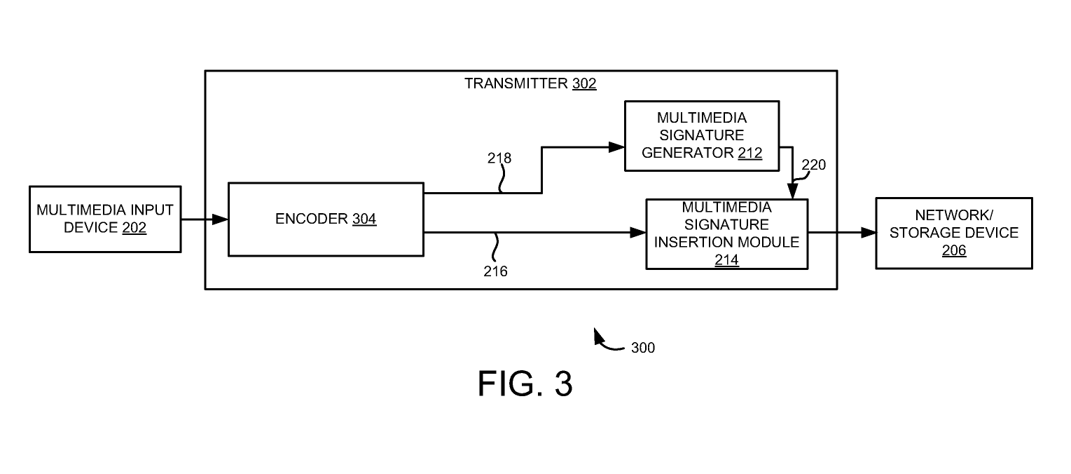

Referring now to FIG. 3, which is another block diagram 300 that illustrates major components of a transmitter 302 and their interconnectivity, according to one embodiment. As shown in FIG. 3, the block diagram 300 includes the multimedia input device 202, the transmitter 302 and the network or storage device 206. Further, the transmitter 302 includes an encoder 304, the multimedia signature generator 212 and the multimedia signature insertion module 214. Furthermore, the multimedia input device 202 is coupled to the transmitter 302. Particularly, the multimedia input device 202 is coupled to the encoder 304. In addition, the encoder 304 is coupled to the multimedia signature generator 212 and the multimedia signature insertion module 214. Moreover, the multimedia signature generator 212 is coupled to the multimedia signature insertion module 214. Further, the transmitter 302 is coupled to the network or storage device 206.

In operation, the transmitter 302 receives the input multimedia stream from the multimedia input device 202. Particularly, the encoder 304 receives the input multimedia stream from the multimedia input device 202. Further, the encoder 304 encodes the received multimedia stream and sends the encoded multimedia stream 216 to the multimedia signature insertion module 214. Furthermore, the encoder exports the multimedia stream properties 218 of the one or more decodable units to the multimedia signature generator 212. In one embodiment, the encoder 304 identifies the multimedia stream properties 218 of the one or more decodable units in the encoded multimedia stream while encoding the received multimedia stream. The encoder 304 then exports the identified multimedia stream properties 218 of the decodable units to the multimedia signature generator 212. In addition, the multimedia signature generator 212 generates, in real-time, the digital signatures 220 associated with the decodable units using the associated multimedia stream properties 218.

Moreover, the multimedia signature generator 212 embeds the generated digital signatures 220 into the encoded multimedia stream 216 using the multimedia signature insertion module 214. In one embodiment, the multimedia signature generator 212 embeds, in real-time, the generated digital signatures 220 into the encoded multimedia stream 216. In another embodiment, the multimedia signature generator 212 embeds the generated digital signatures 220 into the encoded multimedia stream 216 with a time or byte offset along with information to associate the digital signature with a portion of the encoded multimedia stream. The transmitter 302 then transmits the encoded multimedia stream including the digital signatures to the network or storage device 206. This is explained in more detail with reference to FIG. 2. In one embodiment, the receiver (e.g., the receiver 502 of FIG. 5 or the receiver 602 of FIG. 6) receives the encoded multimedia stream including the digital signatures from the network or storage device 206 and authenticates the received encoded multimedia stream using the digital signatures. This is explained in more detail using FIGS. 5 and 6.

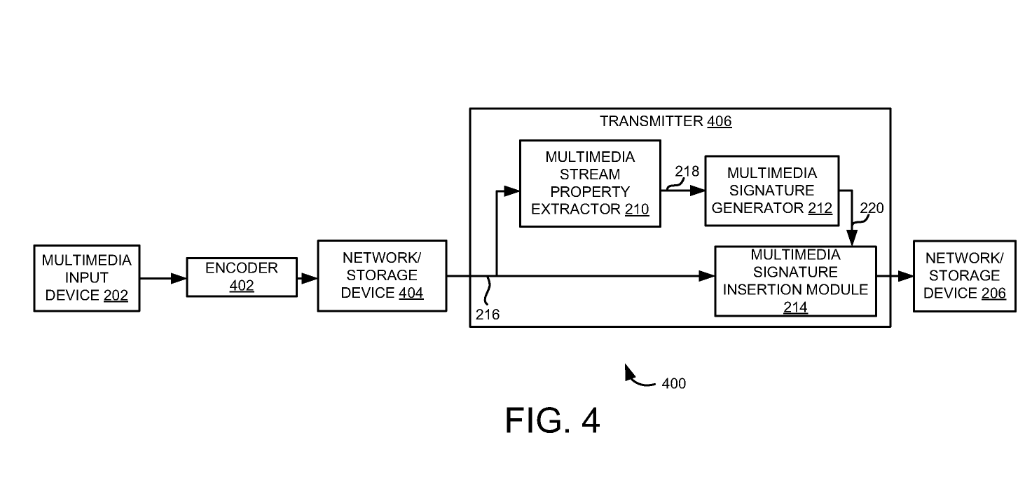

Referring now to FIG. 4, which is yet another block diagram 400 that illustrates major components of a transmitter 406 and their interconnectivity, according to one embodiment. As shown in FIG. 4, the block diagram 400 includes the multimedia input device 202, an encoder 402, a network or storage device 404, the transmitter 406 and network or storage device 206. Further, the transmitter 406 includes the multimedia stream property extractor 210, the multimedia signature generator 212 and the multimedia signature insertion module 214. Furthermore, the multimedia input device 202 is coupled to the encoder 402. In addition, the encoder 402 is coupled to the network or storage device 404. Moreover, the multimedia stream property extractor 210 is coupled to the multimedia signature generator 212. Also, the multimedia signature generator 212 is coupled to the multimedia signature insertion module 214. Further, the transmitter 406 is coupled to the network or storage device 206.

In operation, the encoder 402 receives the input multimedia stream from the multimedia input device 202 and encodes the input multimedia stream. Further, the encoder 402 sends the encoded multimedia stream to the network or storage device 404. Furthermore, the transmitter 406 obtains the encoded multimedia stream 216 from the network or storage device 404. In addition, the multimedia stream property extractor 210 extracts the multimedia stream properties 218 associated with the one or more decodable units from the encoded multimedia stream 216. Moreover, the multimedia stream property extractor 210 sends the extracted multimedia stream properties 218 to the multimedia signature generator 212.

Also, the multimedia signature generator 212 generates the digital signatures 220 associated with the decodable units using the extracted multimedia stream properties 218. Further, the multimedia signature generator 212 embeds the generated digital signatures 220 into the encoded multimedia stream 216 using the multimedia signature insertion module 214. Furthermore, the transmitter 406 transmits the encoded multimedia stream including the digital signatures to the network or storage device 206. This is explained in more detail using FIG. 2. In one embodiment, the receiver (e.g., the receiver 502 of FIG. 5 or the receiver 602 of FIG. 6) receives the encoded multimedia stream including the digital signatures from the network or storage device 206 and authenticates the received encoded multimedia stream using the digital signatures. This is explained in more detail using FIGS. 5 and 6.

Referring now to FIG. 5, which is a block diagram 500 that illustrates major components of a receiver 502 and their interconnectivity, according to one embodiment. As shown in FIG. 5, the block diagram 500 includes the network or storage device 206, the receiver 502 and a multimedia rendering device 504. Further, the receiver 502 includes a decoder 506, a multimedia stream property extractor 508, a multimedia signature generator 510 and a comparator 512. Furthermore, the network or storage device 206 is coupled to the receiver 502. Particularly, the network or storage device 206 is coupled to the decoder 506 and the multimedia stream property extractor 508. In addition, the multimedia stream property extractor 508 is coupled to the multimedia signature generator 510. Also, the multimedia signature generator 510 is coupled to the comparator 512. Further, the decoder 506 is coupled to the comparator 512 and the multimedia rendering device 504.

In operation, the receiver 502 receives the encoded multimedia stream including the digital signatures from the network or storage device 206. Particularly, the decoder 506 and multimedia stream property extractor 508 receive the encoded multimedia stream including the digital signatures from the network or storage device 206. In one embodiment, a transmitter (the transmitter 204 of FIG. 2, transmitter 302 of FIG. 3, and transmitter 406 of FIG. 4) generates the digital signatures associated with the decodable units in the encoded multimedia stream and embeds the generated digital signatures into the encoded multimedia stream. The transmitter then sends the encoded multimedia stream including the digital signatures to the network or storage device 206. This is explained in more detail using FIGS. 2-4. Further, the multimedia stream property extractor 508 extracts multimedia stream properties 514 associated with one or more decodable units in the received encoded multimedia stream and sends the extracted multimedia stream properties 514 to the multimedia signature generator 510. Furthermore, the multimedia signature generator 510 generates one or more digital signatures 520 associated with the decodable units using the extracted multimedia stream properties 514.

In addition, the decoder 506 extracts the embedded digital signatures from the received encoded multimedia stream. The decoder 506 then sends the extracted digital signatures 516 to the comparator 512 and a decoded multimedia stream 518 to the multimedia rendering device 504. Moreover, the comparator 512 compares the extracted digital signatures 516 with the generated digital signatures 520 to determine whether the encoded multimedia stream and the received encoded multimedia stream are identical or not. In one embodiment, the extracted digital signatures 516 are decrypted using a public key. The comparator 512 compares the decrypted digital signatures with the generated digital signatures 520 to determine whether the encoded multimedia stream and the received encoded multimedia stream are identical or not.

Referring now to FIG. 6, which is another block diagram 600 that illustrates major components of a receiver 602 and their interconnectivity, according to one embodiment. As shown in FIG. 6, the block diagram 600 includes the network or storage device 206, receiver 602 and multimedia rendering device 504. Further, the receiver 602 includes a decoder 604, the multimedia signature generator 510, and the comparator 512. Furthermore, the network or storage device 206 is coupled to the receiver 602. Particularly, the network or storage device 206 is coupled to the decoder 604. In addition, the decoder 604 is coupled to the comparator 512 and the multimedia rendering device 504. Moreover, the multimedia signature generator 510 is coupled to the comparator 512.

In operation, the decoder 604 receives the encoded multimedia stream including the digital signatures from the network or storage device 206. In one embodiment, the transmitter (the transmitter 204 of FIG. 2, transmitter 302 of FIG. 3, and transmitter 406 of FIG. 4) generates the one or more digital signatures associated with the one or more decodable units in the encoded multimedia stream and embeds the generated digital signatures into the encoded multimedia stream. The transmitter then transmits the encoded multimedia stream including the digital signatures to the network or storage device 206. This is explained in more detail using FIGS. 2-4. Further, the decoder 604 identifies the multimedia stream properties 514 associated with one or more decodable units in the received encoded multimedia stream while decoding the received encoded multimedia stream.

Furthermore, the decoder 604 exports the identified multimedia stream properties 514 to the multimedia signature generator 510. In addition, the multimedia signature generator 510 generates digital signatures 520 associated with the decodable units using the multimedia stream properties 514. Moreover, the decoder 604 extracts the embedded digital signatures from the received encoded multimedia stream. Also, the decoder 604 sends the extracted digital signatures 516 to the comparator 512 and sends the decoded multimedia stream 518 to the multimedia rendering device 504. Further, the comparator 512 compares the extracted digital signatures 516 with the generated digital signatures 520. This is explained in more detail using FIG. 5.

In one embodiment, an article comprising a non-transitory computer readable storage medium having instructions thereon which when executed by a computing platform result in execution of the above mentioned method. The method described in the foregoing may be in a form of a machine-readable medium embodying a set of instructions that, when executed by a machine, causes the machine to perform any method disclosed herein. It will be appreciated that the various embodiments discussed herein may not be the same embodiment, and may be grouped into various other embodiments not explicitly disclosed herein.

In addition, it will be appreciated that the various operations, processes, and methods disclosed herein may be embodied in a machine-readable medium and/or a machine accessible medium compatible with a computer system and may be performed in any order (e.g., including using means for achieving the various operations). Accordingly, the specification and drawings are to be regarded in an illustrative rather than a restrictive sense.

In various embodiments, systems and methods described with reference to FIGS. 1 through 6 propose a technique for authenticating an encoded multimedia stream using digital signatures. The above technique generates the digital signature which can effectively enable detection of different types of tampering. Further, the generated digital signatures capture the essence of data in each decodable unit to detect instances such as blurring of a portion of an image in the video sequence as well as data pertaining to continuity across decodable units to enable detection of instances where an entire set of decodable units may be deleted. Furthermore, the size of the digital signatures is restricted to a few bytes to minimize overhead of transmission of the digital signatures.

Although certain methods, systems, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A method, comprising:
generating, in real-time, one or more digital signatures associated with one or more decodable units in an encoded multimedia stream; and
embedding the generated one or more digital signatures into the encoded multimedia stream.

2. The method of claim 1, wherein generating, in real-time, the one or more digital signatures associated with the one or more decodable units in the encoded multimedia stream comprises:
generating, in real-time, the one or more digital signatures associated with the one or more decodable units in the encoded multimedia stream using associated multimedia stream properties.

3. The method of claim 1, wherein embedding the generated one or more digital signatures into the encoded multimedia stream comprises:
embedding, in real-time, the generated one or more digital signatures into the encoded multimedia stream.

4. The method of claim 3, wherein embedding, in real-time, the generated one or more digital signatures into the encoded multimedia stream comprises:
embedding, in real-time, the generated associated digital signatures as part of user specific data in each decodable unit.

5. The method of claim 3, wherein embedding, in real-time, the generated one or more digital signatures into the encoded multimedia stream comprises:
appending the generated associated digital signatures at an end of each decodable unit.

6. The method of claim 1, wherein embedding the generated one or more digital signatures into the encoded multimedia stream comprises:
embedding the generated one or more digital signatures into the encoded multimedia stream with a time or byte offset along with information to associate the digital signature with a portion of the encoded multimedia stream.

7. The method of claim 1, wherein embedding the generated one or more digital signatures into the encoded multimedia stream comprises:
encrypting the generated one or more digital signatures using a private key; and
embedding the encrypted digital signatures into the encoded multimedia stream.

8. The method of claim 1, further comprising:
transmitting the encoded multimedia stream including the one or more digital signatures.

9. The method of claim 8, further comprising:
receiving the encoded multimedia stream including the one or more digital signatures;
generating one or more digital signatures associated with one or more decodable units in the received encoded multimedia stream;
extracting the embedded digital signatures from the received encoded multimedia stream; and
comparing the extracted digital signatures with the generated digital signatures to determine whether the encoded multimedia stream and the received encoded multimedia stream are identical or not.

10. The method of claim 9, wherein authenticating the received encoded multimedia stream by comparing the extracted digital signatures with the generated digital signatures comprises:
decrypting the extracted digital signatures using a public key; and
authenticating the received encoded multimedia stream by comparing the decrypted digital signatures with the generated digital signatures.

11. The method of claim 1, wherein the multimedia streams include video streams, audio streams, images and associated metadata.

12. A system, comprising:
a transmitter, wherein the transmitter comprises:
a multimedia signature generator, wherein the multimedia signature generator generates, in real-time, one or more digital signatures associated with one or more decodable units in an encoded multimedia stream and wherein the multimedia signature generator embeds the generated one or more digital signatures into the encoded multimedia stream.

13. The system of claim 12, wherein the multimedia signature generator is configured to:
generate, in real-time, the one or more digital signatures associated with the one or more decodable units using associated multimedia stream properties.

14. The system of claim 13, wherein the transmitter further comprises a multimedia stream property extractor coupled to the multimedia signature generator, wherein the multimedia stream property extractor extracts the multimedia stream properties associated with the one or more decodable units and wherein the multimedia stream property extractor sends the extracted multimedia stream properties to the multimedia signature generator.

15. The system of claim 14, further comprising:
an encoder coupled to the transmitter via a network or storage device or the multimedia stream property extractor, wherein the encoder encodes an input multimedia stream and wherein the encoder sends the encoded multimedia stream to the transmitter via the network or storage device or to the multimedia stream property extractor.

16. The system of claim 13, further comprising:
an encoder coupled to the multimedia signature generator, wherein the encoder identifies the multimedia stream properties associated with the one or more decodable units while encoding an input multimedia stream and wherein the encoder exports the multimedia stream properties to the multimedia signature generator.

17. The system of claim 12, further comprising:
a network or a storage device coupled to the transmitter, wherein the transmitter transmits the encoded multimedia stream including the one or more digital signatures to the network or storage device.

18. The system of claim 17, further comprising:
a receiver coupled to the transmitter via the network or storage device, wherein the receiver comprises:
a decoder;
a multimedia signature generator coupled to the decoder; and
a comparator coupled to the decoder and the multimedia signature generator, wherein the receiver receives the encoded multimedia stream including the one or more digital signatures from the network or storage device, wherein the multimedia signature generator generates one or more digital signatures associated with one or more decodable units in the received encoded multimedia stream and sends the generated digital signatures to the comparator, wherein the decoder extracts the embedded one or more digital signatures from the received encoded multimedia stream, wherein the decoder sends the extracted digital signatures to the comparator and wherein the comparator compares the extracted digital signatures with the generated digital signatures to determine whether the encoded multimedia stream and the received encoded multimedia stream are identical or not.

19. The system of claim 18, wherein the multimedia signature generator is configured to:
generate the one or more digital signatures associated with the one or more decodable units in the received encoded multimedia stream using associated multimedia stream properties.

20. A non-transitory computer-readable storage medium for authenticating an encoded multimedia stream using digital signatures, when executed by a computing device, cause the computing device to:
generate, real-time, one or more digital signatures associated with one or more decodable units in an encoded multimedia stream; and
embed the generated one or more digital signatures into the encoded multimedia stream.

21. The non-transitory computer-readable storage medium of claim 20, further comprising:
transmitting the encoded multimedia stream including the one or more digital signatures.

22. The non-transitory computer-readable storage medium of claim 21, further comprising:
receiving the encoded multimedia stream including the one or more digital signatures;
generating one or more digital signatures associated with one or more decodable units in the received encoded multimedia stream;
extracting the embedded digital signatures from the received encoded multimedia stream; and
comparing the extracted digital signatures with the generated digital signatures to determine whether the encoded multimedia stream and the received encoded multimedia stream are identical or not.
